(19) United States
(12) Patent Application Publication
(10) Pub. No.: US 2008/0060069 A1
(43) Pub. Date: Mar. 6, 2008

(54) METHODS AND APPARATUS FOR DATA TRANSFER

(75) Inventor: David Vindici, Payson, AZ (US)

Correspondence Address: NOBLITT & GILMORE, LLC., 4800 NORTH SCOTTSDALE ROAD, SUITE 6000, SCOTTSDALE, AZ, 85251, US

(73) Assignee: Slingshot Communications, Inc.

(21) Appl. No.: 11/738,309

(22) Filed: Apr. 20, 2007

Related U.S. Application Data
(63) Continuation-in-part of application No. 11/202,721, filed on Aug. 12, 2005.
(63) Continuation-in-part of application No. 11/733,092, filed on Apr. 9, 2007.
(60) Provisional application No. 60/745,208, filed on Apr. 20, 2006.

(51) Int. Cl. H04L 9/32

(52) U.S. Cl. 726/21

(57) ABSTRACT

Methods and apparatus for data transfer according to various aspects of the present invention operate in conjunction with a computer-readable storage medium associated with an account identifier. The storage medium may store a set of computer-executable instructions configured to allow a computer to: provide an account identifier for a data transfer account to a remote system and receive an authorization for data transfer from the remote system. The data transfer account may be deactivated except in response to an activation code. The data transfer system may further include an identification element connected to the storage device and configured to provide the activation code to the remote system at a purchase time of the storage medium.

### CROSS-REFERENCES TO RELATED APPLICATIONS

This application claims the benefit of U.S. Provisional Patent Application No. 60/745,208, filed Apr. 20, 2006, is a continuation-in-part of U.S. patent application Ser. No. 11/202,721, filed Aug. 12, 2005, is a continuation-in-part of U.S. patent application Ser. No. 11/733,092, filed Apr. 9, 2007, and incorporates the disclosure of each such application by reference.

### BACKGROUND OF THE INVENTION

Information delivery has become a ubiquitous aspect of everyday life. Innumerable sources transfer vast amounts of information to consumers via an array of avenues, varying from classic paper-based correspondence to electronic and optical communications. For commercial information that is bought by a user, such as music, motion pictures, and software, delivery of the information is intertwined with issues of purchasing, storing, and controlling the information.

The classic system for purchasing, delivering, and storing information requires delivery of a medium with the information already stored on the medium. The medium may be purchased at a retail outlet or ordered, at which time the buyer pays for the information. The information is then transferred to the buyer by delivering the medium, like a CD-ROM, which the buyer may then use. The process requires, of course, the cost and complexity associated with distribution of the physical medium. In addition, the user must buy a prepackaged selection of information with no opportunity to adjust the content on the medium. Given fluctuations and variations in consumer preferences, inventory management may add to cost and complexity.

With the proliferation of the Internet, another common technique includes requesting electronic information and gaining access to the information by providing payment. The information is then transferred electronically to the user's computer. The user may then use the computer to access the information. This technique avoids the problems of delivering an independent medium, and the user gains more control over the content selection. To use the information on a system other than the original computer, however, the user must transfer the information to another medium or transport the computer itself. In addition to the time and difficulty associated with transferring the information to an alternative medium, in many cases, the seller of the information may not authorize transfer to another medium or may limit the number of transfers.

### SUMMARY OF THE INVENTION

Methods and apparatus for data transfer according to various aspects of the present invention operate in conjunction with a computer-readable storage medium associated with an account identifier. The storage medium may store a set of computer-executable instructions configured to allow a computer to: provide an account identifier for a data transfer account to a remote system and receive an authorization for data transfer from the remote system. The data transfer account may be deactivated except in response to an activation code. The data transfer system may further include an identification element connected to the storage device and configured to provide the activation code to the remote system at a purchase time of the storage medium.

### BRIEF DESCRIPTION OF THE DRAWINGS

A more complete understanding of the present invention may be derived by referring to the detailed description and claims when considered in connection with the following illustrative figures. In the following figures like reference numbers refer to similar elements and steps throughout the figures.

FIG. 1 is a view of one embodiment of a packaging apparatus including a backing, a film, and a storage medium.

FIG. 2 is a view of an embodiment of a packaging apparatus including an activation card.

FIG. 3 is a view of an embodiment of a packaging apparatus including multiple storage media.

FIG. 4 is a view of an embodiment of a packaging apparatus including various storage media.

FIG. 5 is a view of an embodiment of a packaging apparatus in which the film is peeled back for removal of the storage medium.

FIG. 6 is a view of an embodiment of a packaging apparatus including an activation card and an additional information system.

FIG. 7 is a view of an embodiment of a packaging apparatus including an activation card and additional information systems.

FIG. 8 is a flowchart of an embodiment of a method for data transfer.

FIG. 9 is a flowchart for gaining access to resources for data transfer.

FIG. 10 is a block diagram of various interconnected systems.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ various materials, media, and components, e.g., cards, films, storage media, backings, and/or the like, which may carry out a variety of operations. In addition, the present invention may be practiced in conjunction with any number of storage media, hardware packaging systems, and communications networks, and the system described is merely one exemplary application for the invention. Further, the present invention may employ any number of conventional techniques for activation of a software program, transmission of a verification signal, applying films, creating backings, providing storage media, activating products, and/or the like.

Various representative implementations of the present invention may be applied to any system for data transfer. Certain representative implementations may include, for example, distribution of a software program via a storage medium embedded with the software program, distribution and registration of consumer products via remote database authorization, and/or the like.

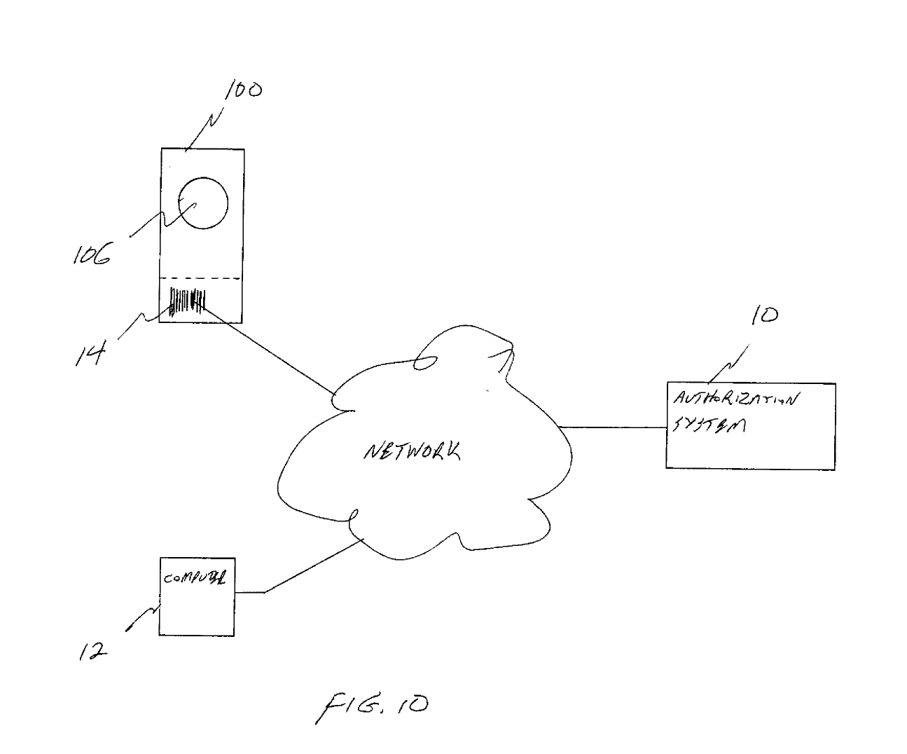

Referring now to FIG. 10, methods and apparatus for data transfer according to various aspects of the present invention operate in conjunction with a packaging system 100 containing: a storage medium 106; an authorization system 10; and a computer 12. The storage medium 106 is associated with an identifier and an account stored in the authorization system 10. The packaging system 100 includes an activation code 14 which may be provided to the authorization system 10 to activate the associated account. The user may then use the computer 12 to access goods and services via the storage medium 106 when the authorization system 10 indicates that the account has been activated.

The computer 12 may comprise any system for utilizing the storage medium 106. For example, the computer 12 may comprise a personal media player, a telephone, a personal digital assistant, a television, or other communication system. In the present embodiment, the computer 12 comprises a conventional personal computer.

The authorization system 10 controls access to the goods or services associated with the storage medium 106. The authorization system 10 may comprise any system for controlling access, such as a remote database storing account information. The authorization system 10 may control access according to any appropriate mechanism. In the present embodiment, the authorization system 10 may designate the account associated with the storage medium 106 as deactivated until properly activated. Therefore, if the storage medium 106 is stolen or otherwise improperly used before proper authorization, the storage medium 106 does not grant access to the goods or services.

When the authorization system 10 receives the activation code 14, the authorization system 10 changes the status of the account to activated. The storage medium 106 may then be used to access the goods or services. The activation code 14 may be received in any appropriate manner, such as via a remote connection. In the present embodiment, the activation code 14 may be generated by a merchant system upon purchase of the storage medium 106.

The authorization system 10 may also require additional information to grant access to the goods or services. For example, when the user attempts to access the goods or services using the computer 12, the authorization system 10 may require an access key from the computer 12 to ensure that the user is authorized to use the account. For example, the authorization system 10 may require a password or other software-based key to ensure that the user is authorized to access the account via the storage medium 106. The authorization system 10 may require additional information as well, such as an identifier from the storage medium 106

The value of the account may be fixed or adjustable. For example, the account may provide ten hours of Internet access. Alternatively, the account may be configured to allow the user to provide additional funds, for example to purchase additional time, to purchase additional access, to purchase additional data, and/or the like. The goods and/or services may be unlimited or limited according to any suitable criteria, such as a particular duration, an amount of data, a number of files, and/or the like.

In addition, the goods and/or services may be provided through multiple providers. For example, the storage medium 106 may be configured to grant Internet access upon authorization of the account by the authorization system 10 and submission of the proper identifier by the storage medium 106. In one embodiment, the account may facilitate Internet access through several Internet service providers (ISPs). An account identifier may be provided by the storage medium 106 to the authorization system 10 via one of the ISPs. When the account identifier is provided to the authorization system 10, the ISP system also provides an ISP identifier for the ISP. When authorization is received from the authorization system 10, the ISP may grant access to the Internet. In addition, the authorization system 10 may note the ISP identifier, for example to credit funds associated with the storage medium 106 and the identifier to the proper ISP. Thus, when the user desires Internet services, the account may grant access to Internet services through a first provider when the user is at one location, such as a coffee shop, and then grant access to the Internet services at another time when the user is at a different location, such as the airport.

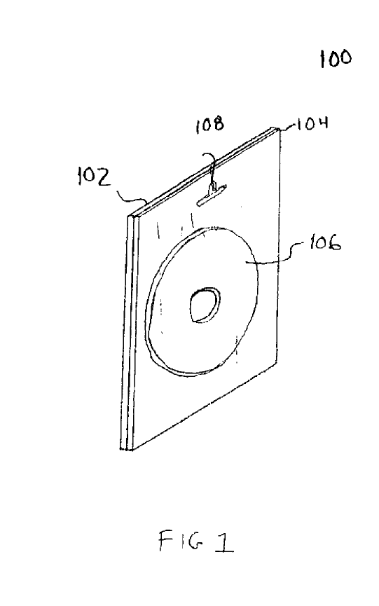

Referring now to FIG. 1, the packaging system 100 according to various aspects of the present invention may secure the storage medium 106 to a backing 102. The packaging system 100 may comprise any system for containing the storage medium 106. In the present embodiment, the storage medium 106 is disposed between the backing 102 and a film 104 that adheres to the backing 102, for example due to evacuation of material between the film 104 and the backing 102. As a result the storage medium 106 is substantially immobilized between the backing 102 and the film 104.

In addition to containing the storage medium 106, the packaging system 100 may facilitate distribution of the storage medium 106 in commerce, such as by providing security features, robustness during shipping, efficiency of packaging, orderly tracking, and/or the like. For example, the storage medium 106 may provide access to goods and/or services upon activation of the account associated with the storage medium 106. As another example, the packaging system 100 may protect the storage medium 106 from environmental hazards, such as ultraviolet light, moisture, vibration, extreme temperatures, and/or the like. The packaging system 100 may also comprise one or more machine-readable identification tags to facilitate tracking of the storage medium 106 in commerce, for example to provide the activation code 14 to the authorization system 10.

Further, the packaging system 100 may conform to a display scheme. For example, the backing 102 and/or the film 104 may be transparent such that the storage medium 106 may be viewed clearly by potential customers. As another example, the backing 102, the film 104, and/or the storage medium 106 may include visual markings, such as a coloration, product information, trademarks, directions, warnings, and/or the like. Further, the packaging system 100 may include features for affixing the packaging system 100 to a specified display scheme. For example, the packaging system 100 may include a notch 108 defining a hole through which a support structure, such as a hanger, may pass. The notch 108 may support the weight of the backing 102, the film 104, and the storage medium 106 on the support structure.

The backing 102 may comprise any element for protecting the storage medium 106 and/or providing structural support to the packaging system 100. For example, the backing 102 may comprise a piece of material having dimensions exceeding that of the storage medium 106 such that the backing 102 receives impacts instead of the storage medium 106. In the present embodiment, the backing 102 comprises a substantially rectangular piece of paperboard or other resilient or substantially rigid material having dimensions such that the storage medium 106 may be secured entirely within the perimeter of the backing 102. In addition, in the present embodiment, the backing 102 includes the notch 108 to facilitate display of the packaging system 100.

The backing 102 may be adapted to the item 106, the anticipated display technique, or other relevant criteria. The backing 102 may be sized and/or comprised of a material to provide robustness with regard to anticipated conditions, such as bending and stacking. In addition, the backing 102 may have a geometry corresponding to the storage medium 106, for example a circular backing 102 paired with a circular storage medium 106, or unrelated to the storage medium 106, for example a rectangular backing 102 paired with an ovoid storage medium 106, and/or the like. Further, the backing 102 may comprise any suitable material, such as cellulose, cotton, wool, polymer, combinations or derivatives of such materials, and/or the like. The backing 102 may be selected and configured for any appropriate material properties, such as cost, elasticity, transparency, reflectivity, adherence, tensile strength, permeability, and/or the like. The backing 102 may comprise a single piece of material or multiple pieces of material coupled together, such as a composite, laminate, multiple pieces of the same material, and/or the like.

The film 104 secures the storage medium 106 to the backing 102 and/or protects the storage medium 106. The film 104 may be adapted according to the application or environment of the packaging system 100, such as elasticity, transparency, reflectivity, adherence, tensile strength, permeability, and/or the like. In addition, the film 104 may comprise any appropriate materials, such as cellulose, cotton, wool, polymer, derivatives of such materials, and/or the like. In the present embodiment, the film 104 comprises a piece of the substantially transparent polymer skin resin sold under the tradename Surlyn®. The polymer skin may comprise ethylene acid copolymers in which the acid groups are partially neutralized with either zinc or sodium ions. The skin may be formed to substantially the same dimensions as one face of the backing 102, to cover only a portion of one face the backing 102, to cover multiple faces of the backing, and/or the like.

The film 104 may secure the storage medium 106 to the backing 102 in any suitable manner. For example, the film 104 may be coupled to the backing 102 via an adhesive, mechanical fastener, molecular bonds between the film 104 and the backing 102, vacuum seal between the backing 102 and the film, and/or the like. In the present embodiment, the film 104 adheres to one face of the backing 102 and to a surface of the storage medium 106 by virtue of evacuation of material between the backing 102 and the film 106. The film 104 may adhere to the backing 102 in multiple layers. For example, multiple pieces of polymer material may be coupled to a single backing 102 on top of one another, side-by-side, overlapping, and/or the like.

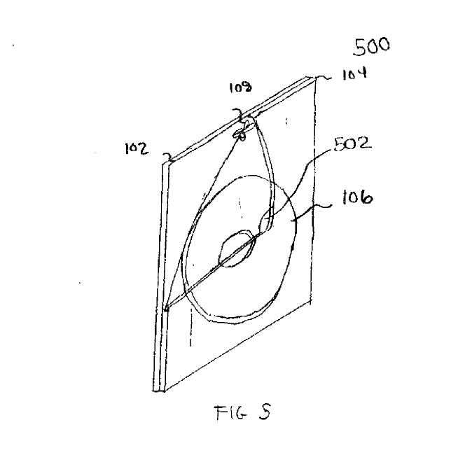

The film 104 may be configured to decouple from the backing 102, such as by peeling, shattering, tearing, shredding, fracturing, deforming, and/or the like. In one embodiment, referring to FIG. 5, a region of the backing 102 is configured to detach from the rest of the backing to facilitate the peeling the film 104 away from the backing 102 to expose the storage medium 106. Removal of the storage medium 106 from the backing 102 by peeling back the film 104 may also protect the storage medium 106 from inadvertent damage caused by the user, for example, in attempting to retrieve the storage medium 106 from the packaging system 100.

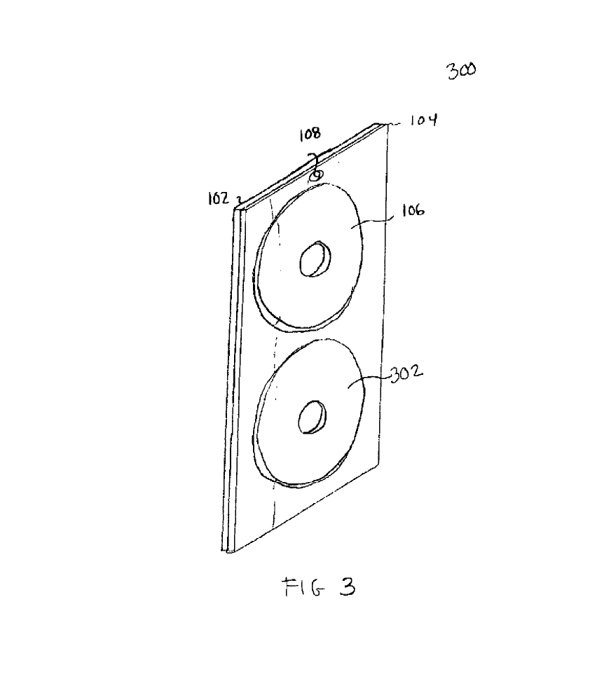

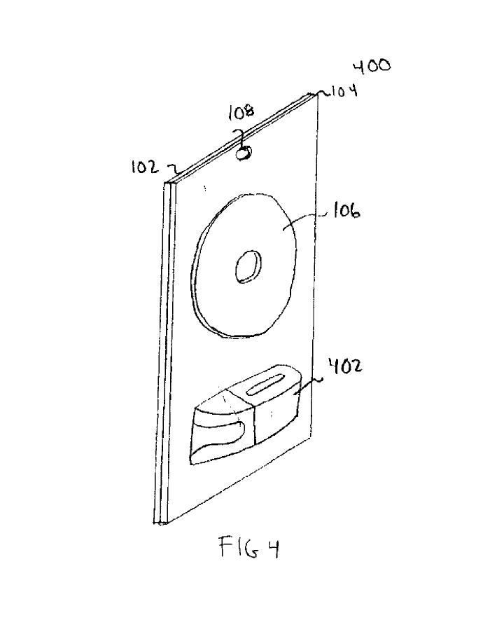

The storage medium 106 may comprise any material suited for distribution and/or packaging and storing the software for gaining access to the goods and services provided via the storage medium 106, such as a compact disc, flash memory device, magnetic disc memory device, magnetic film memory device, device comprising various memory technologies, and/or the like. The storage medium 106 may comprise a write-once medium allowing a user to record information in a single session only, or may be re-writable, erasable, read-only, and/or the like. More than one storage medium 106 may be coupled to a single backing 102. For example, referring to FIGS. 3 and 4, the packaging system 100 may accommodate multiple identical storage media 106, 302 or different storage media 106, 402.

The storage medium 106 may store any suitable information. For example, the storage medium 106 may store information selected by the user, programs for local use by the user, or communications software. In the present embodiment, the storage medium 106 includes a program for gaining access to the authorization system and, if authorized, providing access to the goods or services. The storage medium 106 may also or alternatively store purchased information and/or additional content provided by the seller or other entity.

The storage medium 106 may include other content, such as security measures, instructions for using the storage medium 106 and/or a relevant download service, marketing materials, authorization codes, and/or remote access programs. For example, the storage medium 106 may include a software-based security key to inhibit access to or unauthorized copying of the information on the storage medium 106. Thus, to use the storage medium, the user must provide the access code. In addition, the storage medium 106 may include a program or content that facilitates gaining access to information, such as a program for establishing communication with a remote source to download information and/or security codes for establishing authorization to access protected content.

In one embodiment, the storage medium 106 comprises an optical or magnetic data storage system for accessing network-based services, such as Internet service. For example, the storage medium 106 may comprise a computer-readable optical disk that operates with a computer to receive and/or utilize goods and/or services via a network, such as music, video, and/or game downloading and access services, or telephone and/or Internet services. In the present embodiment, the storage medium 106 comprises a compact disc or minidisk containing software configured to provide access to the Internet, music, video, gaming and/or other web portal prepaid services associated with a prepaid account. The storage medium 106 includes authorization software to facilitate access to the relevant services or goods in conjunction with the authorization system 10. Before gaining full access to the relevant goods or services, the authorization software contacts the authorization system 10 to determine whether the account has been activated. If so, the authorization system 10 grants access. If not, the authorization system 10 denies access.

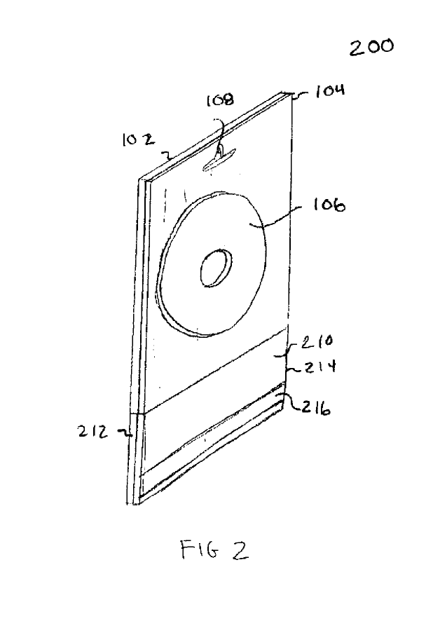

Referring to FIG. 2, the packaging system 100 may further include the activation code 14 associated with the account number to facilitate activation of the account. The activation code 14 may be associated with the storage medium 106 and the account in any suitable manner. For example, an activation card 210 may be coupled to the backing 102, the film 104, and/or the storage medium 106. The activation card 210 may include the activation code 14, which may comprise any mechanism for activating or otherwise using the storage medium 106 after the storage medium 106 has been properly purchased by a user. For example, the activation card 210 may provide instructions for contacting the authorization system 10 to facilitate use of the storage medium 106. The authorization system 10 may then note the account as activated and permit use of the services or goods associated with the account.

If the authorization system 10 recognizes the storage medium 106 as properly purchased, the authorization system 10 may grant access, such as by generating an authorization signal. When the storage medium 106 and/or the ISP grants access in response to the authorization signal, the user may use the storage medium 106, the software on the storage medium 106, and/or the services provided in conjunction with the software.

If the authorization system 10 does not recognize the storage medium 106 as properly purchased, the authorization system 10 may fail to generate the authorization signal and the storage medium 106 and/or the account may remain deactivated. The authorization system 10 may deactivate the account in the event that the authorization system 10 detects that the storage medium 106 and/or an electronic file stored on that File has been improperly activated, stolen, or otherwise improperly used.

In the present embodiment, the activation card 210 comprises a card backing 212, a card film 214, and an information tag 216. The card backing 212 provides a structure for the card film 214 and the information tag 216. The card film 214 may protect the activation card 210, for example, by preventing damage to the activation card 210 during handling and to keep the activation card 210 attached to the remainder of the packaging system 100. The information tag 216 may provide the mechanism for the use and/or activation of the storage medium 106.

The activation card 210 may operate with more than one storage medium 106. Such a configuration may allow multiple storage media 106 to be activated by one activation card 210. This arrangement may be suitable, for example, for low security storage media 106 such as low value software programs embedded on a computer-readable memory device, and/or the like. Conversely, one storage medium 106 may be configured for operation with multiple activation cards 210. Such a configuration may require plural activations to activate the storage medium 106. This arrangement may be suitable, for example, for high security storage media 106 such as high value software programs embedded on a computer-readable memory device.

The activation card 210 may be associated with the other components of the packaging system 200 in any suitable manner. For example, the activation card 210 may be attached to or form a part of the backing 102. The activation card 210 may be separated from the storage medium 106 so that the user may keep the information separate and secure, for example, by tearing along a perforated portion of the backing 102, cutting along a portion of the backing 102, and/or the like. The activation card 210 may also be separate and distinct from the other components of the packaging system 200 such that the activation card 210 and the backing 102, the film 104, and the storage medium 106 are not parts of a single larger unit. For example, the activation card 210 may be distributed separately from the backing 102, the film 104, and the storage medium 106 so as maintain the activation card 210 in a secure location at the point-of-purchase. Consequently, an unauthorized user may be prevented from use of the storage medium 106 without the activation card 210. The activation card 210 may be configured to exhibit any suitable properties, including elasticity, transparency, reflectivity, adherence, tensile strength, permeability, and/or the like. For example, the activation card 210 may have any appropriate dimensions and comprise any suitable material according to a particular application or environment.

The card backing 212 may comprise any system for providing structure to the card film 214 and the information tag 216. The card backing 212 may be substantially similar to the main backing 102 with regard to choice of materials. In one embodiment, the card backing 212 may be defined as a region of the backing 102. In another embodiment, the card backing 212 may comprise a structure distinct from the backing 102 and comprise different materials than the backing 102. In the present embodiment, the card backing 212 comprises a substantially stiff, inexpensive material, such as card stock or paperboard, and is comprised of the same materials as the backing 102. Further, in the present embodiment, the card backing 212 is a defined by a perforation 604 within the backing 102.

The card film 214 may comprise any suitable material for protecting the activation card 210 and/or securing the information tag 216 or any other appropriate items to the card backing 212. In the present embodiment, the card film 214 comprises an extension of the film 104. The card film 214 may cover all or only a portion of the activation card 210, such as a portion of a single surface. Alternatively, the card film 214 may be omitted, for example, if the card backing 212 is sufficiently robust for shipping and display purposes and covering the card backing 212 would significantly increase the cost of production.

The information tag 216 may comprise any system for providing information relating to activation of the storage medium 106 and may be used for any suitable purpose, such as to instruct the user regarding use of the storage medium 106 and/or to facilitate activation of the storage medium 106. The information tag 216 may comprise any suitable mechanism for providing information, such as a visible serial number, a magnetic strip, a Universal Product Code (UPC) mark, a Radio Frequency Identification (RFID) tag, a device compatible with the wireless networking system sold under the tradename BlueTooth®, and/or the like.

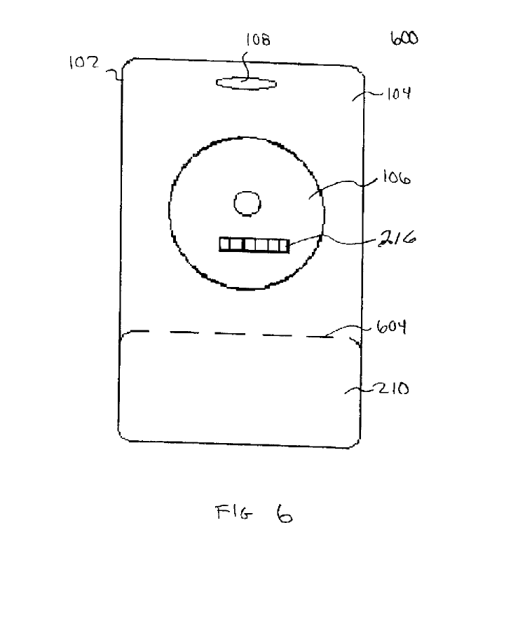

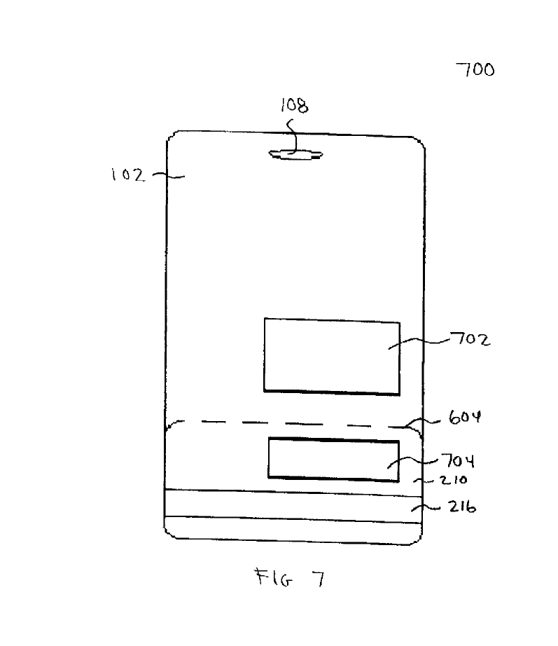

Referring to FIG. 6, the information tag 216 may be located on the activation card 210 or any other suitable location, such as on the storage medium 106 or on other regions of the packaging system 200. Alternatively, the information tag 216 may be provided separately, such as at the time of purchase or upon providing proof of purchase. The packaging system 200 may also include multiple information tags 216, for example, on both the activation card 210 and the storage medium 106. Referring to FIG. 7, multiple information tags 702, 704 may be configured to interoperate with various other information tags or systems, such as a specific information tag 602 specific to the storage medium 106 and/or a general information tag 216. The combination of some of multiple information tags 216, 702, 704 may be configured to provide capabilities including additional security, inventory management for the various distributors of the packages, and/or the like.

The information tag 216 may store any suitable information. For example, in the present embodiment relating to prepaid, network-related services, the information tag 216 may store information such as value information, manufacturer information, password information, encryption information, information for use in conjunction with the information tag 216, and/or the like. The information tag 702 coupled to the backing 102 may be configured to provide information relating to the backing 102 as distinct from the storage medium 106 and activation card 210, for example to verify that the storage medium 106, backing 102, and activation card 210 are grouped as they were upon packaging, to indicate when the system was packaged, by whom the system was packaged, to whom the package was shipped, and/or the like.

In the present embodiment, the information tag 216 facilitates communication with the authorization system 10 such that each proper purchase of the storage medium 106 may be recorded and the corresponding verification signal transmitted. The information tag comprises a conventional bar code including the activation code 14. When the bar code is scanned, the activation code 14 may be provided to the authorization system 10. The information tag may also include other information, such as the access code to access the storage medium.

The present packaging system 100 may be created by securing one or more storage media 106 to the backing 102, such as via a fastener, through an adhesive material, with shrink-wrap, via vacuum seals, and/or the like. In the present embodiment, the packaging system 100 secures the storage medium 106 between the backing 102 and the film 104 by virtue of evacuation of material between the film 104 and the backing 102.

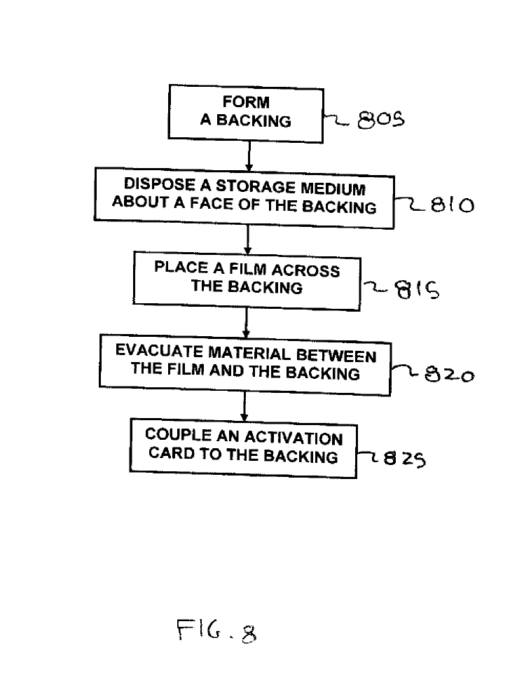

For examples referring to FIG. 8, the backing 102 may be initially formed (805). The storage medium 106 may be disposed upon a face of the backing 102 (810). The film 104 may be placed across the backing 102 (815). Material may be evacuated from between the film 104 and the backing 102 (820) to seal the film 104 to the backing 102 and the storage medium 106. The evacuation process (820) may be tailored to any relevant technique or machine. For example, if the film 104 is the polymer resin sold under the trademark Surlyn®, the film 104 may be coupled to the backing 102 (820) in accordance with the vacuum sealing process marketed under the tradename Stretch Pak.

The activation card 210 may be coupled to the backing 102 (825). In embodiments where the activation card 210 is a distinct portion of the backing 102, this processing step may involve perforating or folding of the unitary backing material to demarcate the activation card 210 and the backing 102. In embodiments where the activation card 210 and the backing 102 are otherwise separate structures, the activation card 210 may be coupled to the backing 102 by way of adhesives, mechanical fasteners, and/or by including the activation card 210 during process of sealing the film 104 to the backing 102. The activation card 210 and backing 102 may by coupled inasmuch as both the activation card 210 and the backing 102 are coupled to the film 104.

To use the storage medium 106 of the present embodiment, the storage medium 106 and/or the account associated with the storage medium 106 may be noted as activated upon proper authorization, such as upon purchase of the storage medium 106. When attempting to use the storage medium 106, the authorization system 10 may determine whether use of the storage medium 106 is authorized. If so, the authorization system 10 and/or the storage medium 106 may further require additional information from the user, such as the access code from the activation card 210, to permit access to the goods and/or services.

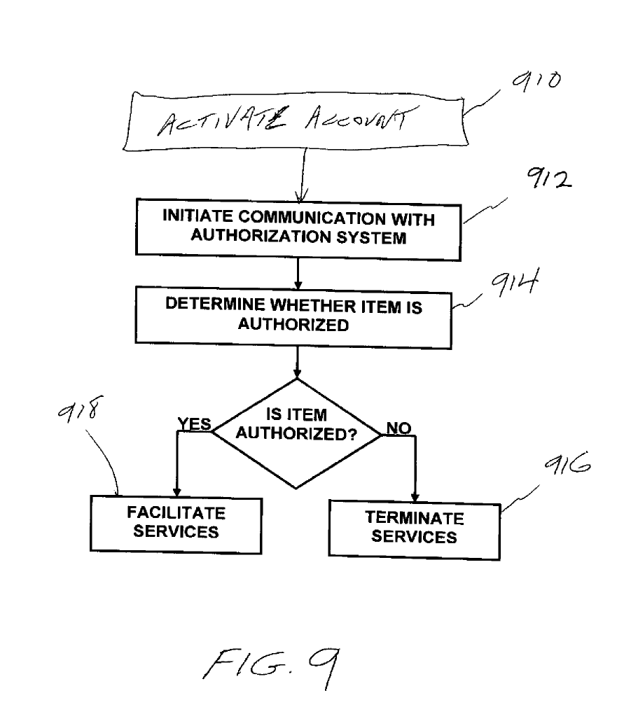

For example, referring to FIG. 9, the storage medium 106 may be initially deactivated such that even if the user provides the access code, the storage medium 106 does not provide access to the goods and services. The storage medium 106 may be activated at any appropriate time and via any suitable mechanism. For example, at the time of purchase, one or more of the information tags 216 may provide instructions for or otherwise facilitate communication with the authorization system 10 (910), such as automatically via an electronic point-of-sale system.

In one embodiment, an electronic system connected to the Internet is located at the point-of-sale. The electronic system may be configured to identify the item 106 purchased, such as by scanning of the information tag 216 via an RFID reader, via a UPC reader, entry of a user-readable sequence of numbers, and/or the like. Further, the system may be configured to send an identifier or other activation code 14, such as information stored in the information tag 216, to the authorization system 10. In the present embodiment, to activate the storage medium 106, the identifier for the storage medium 106 is provided along with any other relevant information, such as an amount of goods and/or services purchased, a time and location of purchase, the identity of the purchaser, and the like. The authorization system 10 may store information relating to the item 106, such as whether the item 106 has been purchased, the amount of goods and services purchased and used, dates of expiration, and/or the like.

When the user wishes to use the storage medium 106, the storage medium 106 and/or the user may initiate communication with the authorization system 10 (912). For example, to access prepaid Internet services, the storage medium 106 may be placed in the computer 12 and software is initiated from the storage medium 106. The software causes the computer 12 to contact the authorization system 10, such as via the Internet. The storage medium 106 may provide a unique identifier and/or account information to the authorization system 10, which then determines whether the storage medium 106 is properly activated (914). The authorization system 10 may evaluate purchase records of the storage medium 106 to determine whether the storage medium 106 is activated. If the storage medium 106 is not verified as properly activated, the service may be terminated and the user notified (916).

If the storage medium 106 is verified as properly authorized, the authorization system 10 may facilitate the provision of the services (918), such as pre-paid communications services, pre-paid Internet access, pre-paid subscription services, pre-paid electronic data download services, pre-paid computer gaming services, and/or the like. The authorization system 10 may also receive identification information from the ISP handling the communication. The authorization system 10 may record the ISP identity and associate the access granted to the user to the ISP. The authorization system 10 and/or the ISP may track the amount of time or other resources used as well and deduct the amounts from the prepaid account associated with the storage medium 106 account.

In addition to activation of electronic items 106, the packaging system 100 may be configured to define the terms of use of other types of items 106. For example, the item 106 may comprise an aftermarket automobile part. In the event that the user fails to activate the item 106, for example, by registering the item with the manufacturer's database within a specified timeframe after purchase, the item 106 may have benefits reduced, such as the warranty may automatically lapse, the part may be reported as missing, and/or the like. Alternatively, if the user activates the item 106 in accordance with the activation card, the item 106 may be entitled to specified benefits such as an extended warranty, recycling reimbursement, and/or the like.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, unless otherwise specified, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described with regard to particular embodiments. Any benefit, advantage, solution to problems, or any element that may cause any particular benefit, advantage, or solution to occur or to become more pronounced are not to be construed as critical, required or essential features or components of any or all the claims.

The terms “comprise”, “comprises”, “comprising”, “having”, “including”, <“includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

I claim:

1. A data transfer apparatus for authorization by a remote system, comprising:
a set of computer-executable instructions stored in a computer-readable storage medium, wherein the set of instructions cause a computer to:
provide an account identifier for a data transfer account to the remote system; and
receive an authorization for data transfer from the remote system,
wherein the data transfer account is deactivated except in response to an activation code; and
an identification element connected to the storage medium, wherein the identification element provides the activation code to the remote system at a time of purchase of the storage medium.

2. A data transfer apparatus according to claim 1, further comprising:
a backing; and
a film coupled to the backing, wherein the couple between the film and the backing is formed by evacuation of material along the interface between the film and the backing;
wherein the storage medium is disposed between the film and the backing.

3. A data transfer apparatus according to claim 2, wherein the identification element is attached to at least one of the storage medium, the backing, and the film.

4. A data transfer apparatus according to claim 1, wherein the storage medium stores a network access software program.

5. A data transfer apparatus according to claim 1, further comprising an activation element connected to the storage medium and including a software-based key, wherein:
the storage medium is responsive to the software-based key, and
the storage medium is at least partially deactivated except in response to a confirmation signal from the storage medium confirming receipt of the software-based key within the remote system.

6. A data transfer apparatus according to claim 1, wherein the authorization comprises access to the Internet.

7. A data transfer apparatus according to claim 6, wherein the Internet access is for a specified quantity of access.

8. A data transfer apparatus according to claim 6, wherein the Internet access is granted via at least one of multiple Internet service providers.

9. A data transfer apparatus according to claim 1, wherein the film comprises a substantially transparent resin.

10. A method for authorization by a remote system, comprising:
distributing a computer-readable storage medium storing a set of computer-executable instructions, wherein:
the set of instructions is configured to cause a computer to provide an account identifier for a data transfer account to the remote system; and
the data transfer account is deactivated except in response to an activation code; and
providing the activation code to the remote system at a time of purchase of the storage medium, wherein the activation code is embodied in an identification element connected to the storage medium.

11. A method For authorization according to claim 10, wherein:
the storage medium is disposed between a film and a backing; and
the couple between the film and the backing is formed by evacuation of material along the interface between the film and the backing.

12. A method for authorization according to claim 10, wherein the identification elements is attached to at least one of the storage medium, the backing, and the film

13. A method for authorization according to claim 10, wherein the storage medium stores a network access software program.

14. A method for authorization according to claim 10, further comprising:
distributing a software-based key included with an activation element, wherein:
the activation element is connected to the storage medium,
the storage medium is responsive to the software-based key, and
the storage medium is at least partially deactivated except in response to a confirmation signal from the storage medium confirming receipt of the software-based key within the remote system.

15. A method for authorization according to claim 10, wherein the authorization comprises access to the Internet.

16. A method for authorization according to claim 15, wherein the Internet access is for a specified quantity of access.

17. A method for authorization according to claim 15, wherein the Internet access is granted via at least one of multiple Internet service providers.

18. A method for authorization according to claim 10, wherein the film comprises a substantially transparent resin.

19. A data transfer apparatus for authorization by a remote system, comprising:
a set of computer-executable instructions stored in a computer-readable storage medium and responsive to installation of the storage medium, wherein;
the set of instructions, in response to installation of the storage medium, contacts the remote system, provides to the remote system an account identifier for a
data transfer account, and receives an authorization from the remote system, and
the data transfer account is deactivated except in response to an activation code;
an identification element connected to the storage medium and responsive to purchase of the storage medium, wherein the identification element provides the activation code to the remote system and activates the data transfer account in response to and at the time of purchase of the storage medium;
a backing; and
a film coupled to the backing, wherein:
the couple between the film and the backing is formed by evacuation of material along the interface between the film and the backing, and
the storage medium is disposed between the film and the backing.

20. A data transfer apparatus according to claim 19, wherein the identification elements is attached to at least one of the storage medium, the backing, and the film

21. A data transfer apparatus according to claim 19, wherein the storage medium stores a network access software program.

22. A data transfer apparatus according to claim 19, further comprising an activation element connected to the storage medium and including a software-based key, wherein:
the storage medium is responsive to the software-based key, and
the storage medium is at least partially deactivated except in response to a confirmation signal from the storage medium confirming receipt of the software-based key within the remote system.

23. A data transfer apparatus according to claim 19, wherein the authorization comprises access to the Internet.

24. A data transfer apparatus according to claim 23, wherein the Internet access is for a specified quantity of access.

25. A data transfer apparatus according to claim 23, wherein the Internet access is granted via at least one of multiple Internet service providers.

26. A data transfer apparatus according to claim 19, wherein the film comprises a substantially transparent resin.
